(19) United States
(12) Patent Application Publication
(10) Pub. No.: US 2005/0266727 A1
(43) Pub. Date: Dec. 1, 2005

(54) Coaxial cable shielding terminal

(75) Inventors: Toru Yamaguchi, Haibara-gun (JP); Taishi Morikawa, Haibara-gun (JP); Chitoshi Nakamura, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/939,463

(22) Filed: Sep. 14, 2004

(30) Foreign Application Priority Data
Sep. 16, 2003 (JP) P2003-323349

(51) Int. Cl. H01R 4/24

(52) U.S. Cl. 439/585

(57) ABSTRACT

A press-clamping portion 13 includes a pair of braid press-fastening portions 17 which extend in an upstanding manner respectively from opposite side edges of a terminal bottom plate portion 11, and can be press-connected to a braid 15 of a coaxial cable 3 by press-fastening, and a connecting piece portion 25 which can be inserted at its distal end portion between an inner insulating layer 23 of the coaxial cable 3 and the braid 15 from the end side of the coaxial cable 3 so that the braid 15 can be held between the connecting piece portion 25 and distal end portions of the braid press-fastening portions 17. Grooves 29 of a triangular cross-section are formed in an inner surface of the press-clamping portion 13, and extend in respective directions intersecting a direction of insertion of the coaxial cable 3. Each of the grooves 29 is formed such that that corner of the triangle, defining a bottom of the groove 29, is located upstream of a center of an opening of the groove 29 in the direction of insertion of the coaxial cable 3.

### BACKGROUND OF THE INVENTION

1. Field of the Invention

This invention relates to a shielding terminal for a coaxial cable, and more particularly to a coaxial cable shielding terminal for being press-connected to an end portion of the coaxial cable.

2. Related Art

Generally, in order to intercept electrical noises such as electromagnetic waves and static electricity, a coaxial cable, used as an antenna wire or the like, has a construction in which a conductor, covered with an inner insulating layer, is covered with a braid, and further this braid is covered with an insulating sheath. There have been proposed various coaxial connectors for connecting such a coaxial cable to a mating equipment or a mating connector. In such coaxial connectors, there has been used a coaxial cable shielding terminal for connecting the braid of the coaxial cable to the mating connector for grounding purposes.

A conventional coaxial cable shielding terminal is formed by pressing a metallic sheet into a trapezoidal box-shape, and a connector mounting portion is provided at a distal end portion thereof with a larger width, while a press-clamping portion for press-connection to a coaxial cable is provided at a proximal end portion thereof with a smaller width. The press-clamping portion includes a pair of press-fastening portions extending upwardly respectively from opposite side edges of a base plate portion, and a connecting piece portion provided between the press-fastening portions. The connecting piece portion is spaced from the press-fastening portions in generally parallel relation thereto, and is curved into an arcuate shape corresponding to the shape of an outer peripheral surface of an inner insulating layer of the coaxial cable which is to be connected to the shielding terminal shown in Unexamined Japanese Utility Model Publication Hei. 5-90855.

For connecting this coaxial cable shielding terminal to the coaxial cable, the connecting piece portion is inserted between the braid and inner insulating layer of the coaxial cable, and then in this condition the pair of press-fastening portions are press-deformed. As a result, the press-fastening portions of the coaxial cable shielding terminal press and urge the braid of the coaxial cable toward the connecting piece portion of the coaxial cable shielding terminal, so that the degree of intimate contact of the connecting piece portion of the coaxial cable shielding terminal with the inner peripheral surface of the braid of the coaxial cable is enhanced so as to suppress the occurrence of the incomplete connection between the braid of the coaxial cable and the coaxial cable shielding terminal by the connecting piece portion of the coaxial cable shielding terminal.

In the coaxial cable shielding terminal shown in Unexamined Japanese Utility Model Publication Hei. 5-90855, although the press-fastening portions are press-fastened onto the insulating sheath, it has also been proposed to cut the insulating sheath to expose the braid and then to press-fasten the press-fastening portions onto the exposed braid. By thus press-fastening the press-fastening portions of the coaxial cable shielding terminal onto the exposed braid of the coaxial cable, the braid is gripped by the press-fastening portions and the connecting piece portion, and also the press-fastening portions and the connecting piece portion are both held in contact with the braid of the coaxial cable so as to suppress the occurrence of the incomplete contact between the braid of the coaxial cable and the coaxial cable shielding terminal.

However, in the case of press-fastening the press-fastening portions of the coaxial cable shielding terminal onto the exposed braid of the coaxial cable, the exposed braid of the coaxial cable is brought into sliding contact with the inner surface of the press-clamping portion of the coaxial cable shielding terminal when the connecting piece portion of the coaxial cable shielding terminal is inserted between the braid and inner insulating layer of the coaxial cable, that is, when the end portion of the coaxial cable is inserted into the coaxial cable shielding terminal.

On the other hand, grooves of an isosceles triangle-shaped or V-shaped cross-section are usually formed in the inner surface of the press-clamping portion so as to prevent the press-fastened coaxial cable from being withdrawn from the press-clamping portion. These V-shaped grooves are formed to extend in their respective directions intersecting the direction of insertion of the coaxial cable, and therefore when the exposed braid of the coaxial cable contacts the inner surface of the press-clamping portion of the coaxial cable shielding terminal during the insertion of the end portion of the coaxial cable into the coaxial cable shielding terminal, wires, forming the braid, are caught by edges of the grooves, so that the wires of the braid become loose. When the wires of the braid thus become loose, the braid press-fastening portions of the coaxial cable shielding terminal sometimes can not sufficiently press and urge the braid of the coaxial cable toward the connecting piece portion even upon press-fastening of the braid by the braid press-fastening portions, so that the connecting piece portion of the coaxial cable shielding terminal fails to be held in intimate contact with the inner peripheral surface of the braid of the coaxial cable, and therefore the occurrence of the incomplete connection between the coaxial cable braid and the coaxial cable shielding terminal can not be suppressed.

### SUMMARY OF THE INVENTION

An object of this invention is to suppress the occurrence of incomplete connection between a braid of a coaxial cable and a coaxial cable shielding terminal.

The above object has been achieved by a coaxial cable shielding terminal of the invention including a press-clamping portion for being press-connected to an end portion of a coaxial cable, wherein the shielding terminal can be electrically connected to a braid of the coaxial cable exposed at the end portion thereof; characterized in that the press-clamping portion includes a pair of braid press-fastening portions which extend in an upstanding manner respectively from opposite side edges of a terminal bottom plate portion, and can be press-connected to the braid of the coaxial cable by press-fastening, and a connecting piece portion which can be inserted at its distal end portion between an inner insulating layer of the coaxial cable and the braid from the end side of the coaxial cable so that the braid can be held between the connecting piece portion and distal end portions of the braid press-fastening portions; and grooves of a triangular cross-section are formed in an inner surface of the press-clamping portion, and extend in respective directions intersecting a direction of insertion of the coaxial cable; and each of the grooves is formed such that that corner of the triangle, defining a bottom of the groove, is located upstream of a center of an opening of the groove in the direction of insertion of the coaxial cable.

In this construction, the grooves of the triangular shape are formed in the inner surface of the press-clamping portion such that that corner of the triangle, defining the bottom of the groove, is located upstream of the center of the opening of the groove in the direction of insertion of the coaxial cable. Therefore, in the case where the angle between the two opposed surfaces of the groove, that is, the angle of that corner of the triangle defining the bottom of the groove, is the same as that of the conventional grooves of a V-shape, the angle, formed by that surface of the groove (disposed at the downstream side in the direction of insertion of the coaxial cable) and the inner surface of the press-clamping portion when the end portion of the coaxial cable is inserted into the coaxial cable shielding terminal, is larger as compared with the conventional grooves of the V-shape. Therefore, when the end portion of the coaxial cable is inserted into the coaxial cable shielding terminal, wires, forming the braid, are less liable to be caught by an edge of the opening of each groove, that is, a corner portion of the groove, and therefore the wires of the exposed braid are less liable to become loose. Namely, the occurrence of the incomplete connection between the braid of the coaxial cable and the coaxial cable shielding terminal can be suppressed.

Each of the grooves has a right-angled triangular cross-section, and that surface of the groove, disposed at the downstream side in the direction of insertion of the coaxial cable (which is to be connected to the shielding terminal), defines a slanting side of the right-angled triangle. In the case where the inner surface of the press-clamping portion is a flat surface, the angle, formed by that surface of the groove (disposed at the upstream side in the direction of insertion of the coaxial cable which is to be connected to the shielding terminal) and the inner surface of the press-clamping portion, is a right angle. With this construction, the angle, formed by the upstream-side surface of the groove in the direction of insertion of the coaxial cable and the inner surface of the press-clamping portion, is a right angle, and is smaller as compared with the conventional V-shaped grooves, and therefore the coaxial cable is less liable to be withdrawn from the coaxial cable shielding terminal. In the present invention, the occurrence of the incomplete connection between the braid of the coaxial cable and the coaxial cable shielding terminal can be suppressed.

### BRIEF DESCRIPTION OF THE DRAWINGS

FIG. 1 is a perspective view broadly showing the construction of one preferred embodiment of a coaxial cable shielding terminal of the invention;

FIG. 2 is a longitudinal cross-sectional view broadly showing the construction of the coaxial cable shielding terminal of the above embodiment;

FIG. 3 is a cross-sectional view taken along the line III-III of FIG. 2;

FIG. 4 is a cross-sectional view schematically showing the shape of grooves formed in an inner surface of a press-clamping portion of the coaxial cable shielding terminal of the above embodiment;

FIG. 5A shows a condition in which end portions of two coaxial cables to be connected are processed;

FIG. 5B shows a condition in which the coaxial cable shielding terminals are connected respectively to the two coaxial cable shielding terminals;

FIG. 5C shows a condition in which a shielding terminal housing is fitted on the coaxial cable shielding terminals to provide the coaxial connector; and

FIG. 6 is an enlarged transverse cross-sectional view showing the press-clamping portion of the coaxial cable shielding terminal of the invention mounted on the coaxial cable.

### DETAILED DESCRIPTION OF THE PREFERRED EMBODIMENTS

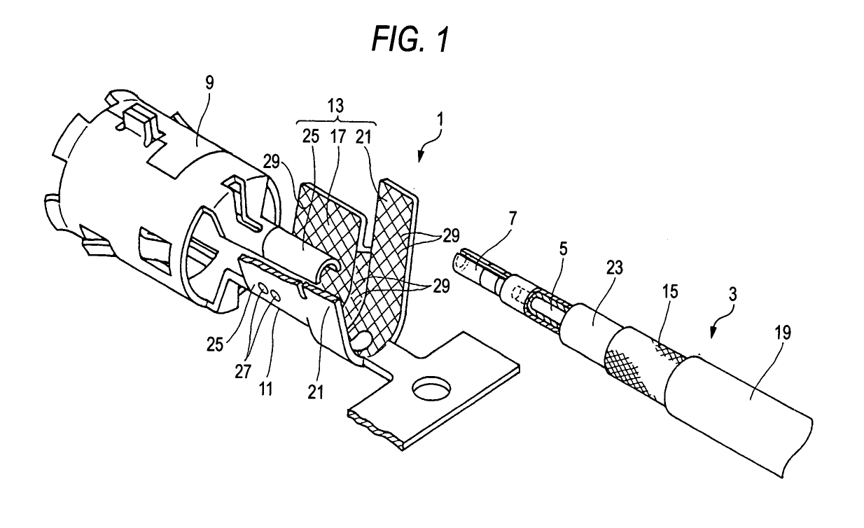

One preferred embodiment of a coaxial cable shielding terminal of the present invention will now be described with reference to FIGS. 1 to 6.

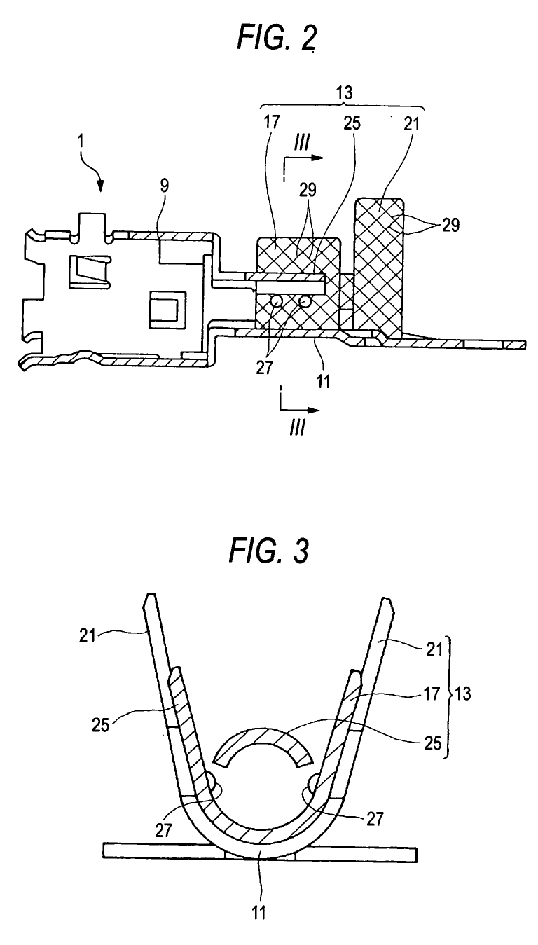

As shown in FIGS. 1 and 2, the coaxial cable shielding terminal 1 of this embodiment is an integrally-formed product formed by pressing a metal sheet, and this shielding terminal includes a terminal body 9 of a cylindrical tubular shape for receiving an inner terminal 7 (which is press-connected to a conductor 5 of the coaxial cable 3) in coaxial relation thereto, a terminal bottom plate portion 11 extending rearwardly from the terminal body 9 along the axis thereof, and the press-clamping portion 13 formed on opposite side edges of the terminal bottom plate portion 11. This shielding terminal is formed into an integral construction, using a metal sheet.

The press-clamping portion 13 includes a pair of braid press-fastening portions 17 which extend in an upstanding manner respectively from the opposite side edges of the terminal bottom plate portion 11, and can be press-fastened to a braid 15 of the coaxial cable 3 to thereby press-connect the coaxial cable shielding terminal 1 to the coaxial cable 3, a pair of sheath press-fastening portions 21 which are disposed rearwardly of the braid press-fastening portions 17, and extend in an upstanding manner respectively from the opposite side edges of the terminal bottom plate portion 11, and can be press-fastened to an insulating sheath 19 of the coaxial cable 3 to thereby press-connect the coaxial cable shielding terminal 1 to the coaxial cable 3, and a connecting piece portion 25 which can be inserted at its distal end portion between an inner insulating layer 23 and the braid 15 from the end side of the coaxial cable 3.

The connecting piece portion 25 has an arcuate plate-shaped transverse cross-section corresponding to the shape of the inner peripheral surface of the braid 15, and this connecting piece portion extends rearwardly from a central portion of a rear end surface of the cylindrical terminal body 9 in parallel relation to the terminal bottom plate portion 11. In this embodiment, the connecting piece portion 25 is formed integrally with the terminal body 9 through interconnecting portions which are bent at an upper portion of the rear edge of the terminal body 9 perpendicularly relative to the circumferential surface of the terminal body 9 to extend toward the axis of the terminal body 9. As shown in FIGS. 1 to 3, a plurality of retaining portions 27 are convexly formed on the inner surfaces of the pair of braid press-fastening portions 17 by embossing (pressing), and when the connecting piece portion 25 is displaced toward the terminal bottom plate portion 11, opposite side edges of the connecting piece portion 25 abut against the retaining portions 27, so that the retaining portions 27 limit the displacement of the connecting piece portion 25 toward the terminal bottom plate portion 11. Two retaining portions 27 are formed on the inner surface of each of the braid press-fastening portions 17, and are arranged in a juxtaposed manner in the direction of extending of the connecting piece portion 25.

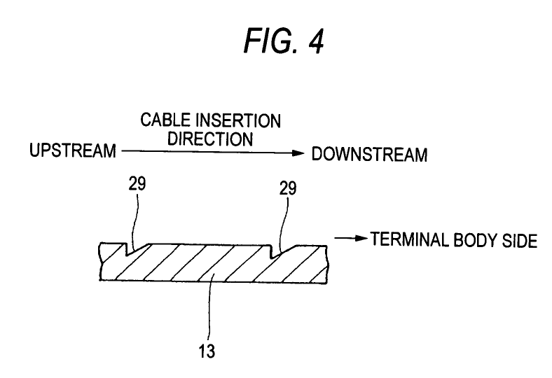

Grooves 29 are formed in a grid-like pattern by knurling in the inner surfaces of the braid press-fastening portions 17 and sheath press-fastening portions 21 of the press-clamping portion 13 and the inner surface of that portion of the terminal bottom plate portion 11 corresponding to the braid press-fastening portions 17 and the sheath press-fastening portions 21. The grooves 29 are formed in a grid-like pattern such that a direction of extending of any of these grooves 29 intersects the direction of extending of the terminal bottom plate portion 11. In this embodiment, each of the grooves 29, formed by knurling, has a right-angled triangular cross-section as shown in FIG. 4, and that corner of this triangle, defining the bottom of the groove 29, is offset from the center of an opening of the groove 29 in a direction away from the terminal body 9. Therefore, with respect to the cross-sectional shape of the groove 29, that surface of the groove 29, disposed close to the terminal body 9, defines a slanting side of the right-angled triangle, and in the case where the inner surface of the press-clamping portion 13 is a flat surface, the angle, formed by that surface of the groove 29 remote from the terminal body 9 and the inner surface of the press-clamping portion 13, is substantially right-angular.

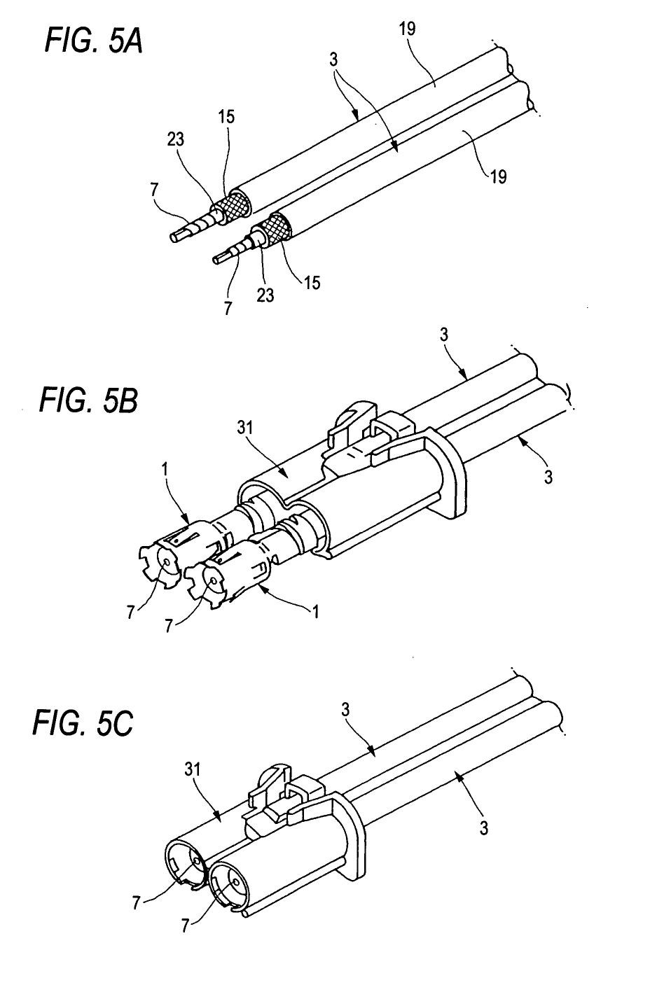

A method of mounting the coaxial cable shielding terminal 1 of this construction on the coaxial cable 3, as well as features thereof, will be described. In the coaxial cable 3, the braid 15 is provided around the inner insulating layer 23 covering the periphery of the conductor 5, and the braid 15 is covered at its outer periphery with the insulating sheath 19 as shown in FIGS. 1 and 5A. In the coaxial cable 3, end portions of the insulating sheath 19, braid 15 and inner insulating layer 23 are removed such that the braid 15, the inner insulating layer 23 and the conductor 5 are exposed respectively over predetermined lengths in a stepped manner.

Then, the inner terminal 7 of a generally cylindrical tubular shape for fitting connection purposes is press-connected to the exposed conductor 5, and thereafter this coaxial cable is press-connected to the coaxial cable shielding terminal 1. At this time, the coaxial cable 3, having the inner terminal 7 mounted on the conductor 5 and also having the exposed braid 15 and the exposed inner insulating layer 23, is inserted into the coaxial cable shielding terminal 1 from the sheath press-fastening portions 21 of the press-clamping portion 13 toward the terminal body 9. During the insertion of the coaxial cable 3 into the coaxial cable shielding terminal 1, the exposed braid 15 of the coaxial cable 3 slides in contact with the inner surface of the press-clamping portion 13. On the other hand, the grooves 29 are formed in the inner surface of the press-clamping portion 13 to extend in their respective directions intersecting the direction of extending of the connecting piece portion 25 and terminal bottom plate portion 11, and therefore the grooves 29 are formed in the directions intersecting the direction of insertion of the coaxial cable 3.

In this embodiment, however, each of the grooves 29 is formed in the inner surface of the press-clamping portion 13 such that the corner of the triangle, defining the bottom of the groove 29, is offset from the center of the opening of the groove 29 in the direction away from the terminal body 9, that is, located upstream of the center of this opening in the direction of insertion of the coaxial cable 3. Therefore, in the case where the corner of the triangle, defining the bottom of each groove formed in the inner surface of the press-clamping portion 13, has the same angle as in the conventional grooves of an isosceles triangle-shaped or V-shaped cross-section, the angle, formed by that surface of the groove 29 of this embodiment (disposed at the downstream side in the direction of insertion of the coaxial cable 3) and the inner surface of the press-clamping portion 13, is larger as compared with the conventional grooves of the isosceles triangle-shaped or V-shaped cross-section, and therefore wires of the braid 15 are less liable to become loose when the braid 15 is brought into contact with that edge of the opening of each groove 29 (that is, that corner portion of the groove 29) disposed at the downstream side in the direction of insertion of the coaxial cable 3.

When the coaxial cable 3 is inserted into the coaxial cable shielding terminal 1, the connecting piece portion 25 is inserted between the inner insulating layer 23 and the braid 15 from the end side of the coaxial cable 3. In this condition, when the braid press-fastening portions 17 of the coaxial cable shielding terminal 1 are press-fastened on the exposed portion of the braid 15 of the coaxial cable 3, the braid 15 is held between the distal end portion of each braid press-fastening portion 17 and the connecting piece portion 25, so that the inner peripheral surface of the braid 15 of the coaxial cable 3 is pressed against the connecting piece portion 25 of the coaxial cable shielding terminal 1. As a result, the coaxial cable shielding terminal 1 for the coaxial cable 3 is electrically connected to the braid 15 of the coaxial cable 3 of the single-core type.

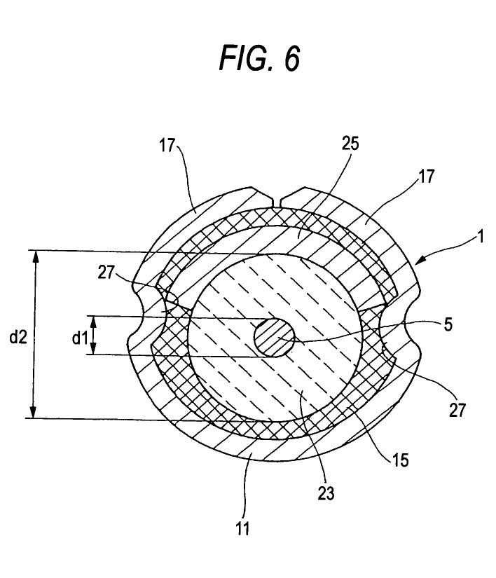

At this time, when the connecting piece portion 25 tends to be displaced toward the terminal bottom plate portion 11, that is, toward the conductor 5 of the coaxial cable 3, by the press-fastening force applied to the braid press-fastening portions 17, the retaining portions 27 of the coaxial cable shielding terminal 1 abut against the opposite side edges of the connecting piece portion 25, thereby limiting the displacement of the connecting piece portion 25 toward the conductor 5 of the coaxial cable 3 as shown in FIG. 6. And besides, the two retaining portions 27 are formed on each braid press-fastening portion, and are juxtaposed in the direction of extending of the connecting piece portion 25, that is, in the direction of the length thereof, and therefore the retaining portions 27 limit the displacement of the connecting piece portion 25 over the entire length of this connecting piece portion 25, and also suppress the inclination of the connecting piece portion 25.

The sheath press-fastening portions 21 of the coaxial cable shielding terminal 1 are press-fastened on the insulating sheath 19 of the coaxial cable 3, and when the braid press-fastening portions 17 and the sheath press-fastening portions 21 (that is, the press-clamping portion 13) are press-fastened, the coaxial cable shielding terminal 1 is press-connected to the end portion of the coaxial cable 3 as shown in FIG. 5B. In this embodiment, the coaxial cable shielding terminals 1, press-connected respectively to the end portions of the coaxial cables 3, are received in a shielding terminal housing 31 made of an insulative resin as shown in FIGS. 5B and 5C. When this shielding terminal housing 31 is fitted to a mating connector housing or the like, the coaxial cable shielding terminals 1 and the inner terminals 7 within the shielding terminal housing 31 are electrically connected respectively to terminals of the mating connector housing.

As described above, in the coaxial cable shielding terminal 1 of this embodiment, each of the grooves 29 of the triangular shape is formed in the inner surface of the press-clamping portion 13 such that the corner of the triangle, defining the bottom of the groove 29, is located upstream of the center of the opening of the groove 29 in the direction of insertion of the coaxial cable 3. Therefore, in the case where the corner of the triangle, defining the bottom of each groove, has the same angle as in the conventional grooves of a V-shape, the angle, formed by that surface of the groove 29 (which is disposed at the downstream side in the direction of insertion of the coaxial cable 3 and with which the braid 15 of the coaxial cable 3 is brought into contact) and the inner surface of the press-clamping portion 13, is larger as compared with the conventional grooves of a V-shape. Therefore, when the end portion of the coaxial wire 3 is inserted into the coaxial cable shielding terminal 1, the wires, forming the braid 15 of the coaxial cable 3, are less liable to be caught by the corner portion of each groove 29, and therefore the wires of the exposed braid 15 are less liable to become loose. Therefore, when the exposed portion of the braid 15 of the coaxial cable 3 is press-fastened by the pair of braid press-fastening portions 17, the braid 15 of the coaxial cable 3 are positively pressed and urged toward the connecting piece portion 25. Therefore, the degree of intimate contact of the connecting piece portion 25 of the coaxial cable shielding terminal 1 with the inner peripheral surface of the braid 15 of the coaxial cable 3, as well as the degree of intimate contact of the braid press-fastening portions 17 with the outer peripheral surface of the braid 15, is enhanced, thereby suppressing the occurrence of the incomplete connection between the braid of the coaxial cable and the coaxial cable shielding terminal.

And besides, in the coaxial cable shielding terminal 1 of this embodiment, each groove 29 has the right-angled triangular shape, and that surface of the groove 29, disposed at the downstream side in the direction of insertion of the coaxial cable 3, defines the slanting side of the right-angled triangle, and in the case where the inner surface of the press-clamping portion 13 is a flat surface, the angle, formed by that surface of the groove 29 (disposed at the upstream side in the direction of insertion of the coaxial cable 3) and the inner surface of the press-clamping portion 13, is right-angular. The angle, formed by that surface of the groove 29 (disposed at the upstream side in the direction of insertion of the coaxial cable 3) and the inner surface of the press-clamping portion 13, is smaller as compared with the conventional V-shaped grooves, and therefore the braid 15 of the coaxial cable 3 is liable to be caught by the corner portion of the groove 29, and the coaxial cable 3 is less liable to be withdrawn from the coaxial cable shielding terminal 1.

In addition, the plurality of retaining portions 27 are formed on the inner surface of each of the braid press-fastening portions 17, and are arranged in the direction of extending of the connecting piece portion 25. Therefore, even when the press-fastening force, applied during the press-connecting operation, acts on the connecting piece portion 25, the retaining portions 27 limit the displacement of the connecting piece portion 25 over the entire length of this connecting piece portion 25 to prevent the connecting piece portion 25 from being inclined, thereby more positively suppressing the occurrence of the incomplete connection between the coaxial cable braid and the coaxial cable shielding terminal.

Incidentally, in the conventional coaxial cable shielding terminal, when the deformed connecting piece portion squeezes the inner insulating layer around the conductor of the coaxial cable connected to the shielding terminal, the distance between the conductor and braid of the connected coaxial cable is changed, and this invites a problem that an impedance in the connected coaxial cable is disturbed, thereby adversely affecting high-frequency characteristics of the connected coaxial cable.

On the other hand, in the coaxial cable shielding terminal 1 of this embodiment, even when the press-fastening force, applied during the press-fastening of the braid press-fastening portions 17, presses and urges the connecting piece portion 25 toward the conductor 5 of the coaxial cable 3, the retaining portions 27 limit the displacement of the connecting piece portion 25 toward the conductor 5 of the coaxial cable 3, and therefore there will hardly be encountered a situation in which the deformed connecting piece portion 25 squeezes the inner insulating layer 23. Particularly, the two retaining portions 27 are formed on the inner surface of each of the braid press-fastening portions 17, and are arranged in the direction of extending of the connecting piece portion 25, and therefore the retaining portions 27 positively keep the connecting piece portion 25 in a horizontal condition, and this also makes it difficult for the deformed connecting piece portion 25 to squeeze the inner insulating layer 23.

Therefore, as shown in FIG. 6, the disturbance of the impedance due to a change in the ratio (d1/d2) of the diameter d1 of the conductor 5 of the coaxial cable 3 to the outer diameter d2 of the inner insulating layer 2 therearound during the press-clamping operation is less liable to occur, so that the high-frequency characteristics of the coaxial cable, press-connected to the coaxial cable shielding terminal 1, are less liable to be adversely affected.

In this embodiment, although each of the grooves 29, formed in the inner surface of the press-clamping portion 13, has the right-angled triangular cross-section, the groove 29 does not need to have such a right-angled triangular cross-section in so far as the corner of the triangle, defining the bottom of the groove 29, is located upstream of the center of the opening of the groove 29 in the direction of insertion of the coaxial cable 3. However, in the case where the inner surface of the press-clamping portion is flat, and the angle, formed by the upstream-side surface of the groove in the coaxial cable-inserting direction and the inner surface of the press-clamping portion, is larger than a right angle, the braid of the coaxial cable is less liable to be caught by the upstream-side edge of the opening in the coaxial cable-inserting direction, so that the effect of preventing the withdrawal of the coaxial cable from the coaxial cable shielding terminal is lowered. On the other hand, in the case where the inner surface of the press-clamping portion is flat, and the angle, formed by the upstream-side surface of the groove in the coaxial cable-inserting direction and the inner surface of the press-clamping portion, is smaller than a right angle, the effect of preventing the withdrawal of the coaxial cable from the coaxial cable shielding terminal is enhanced, but the groove is formed in an undercut manner in the inner surface of the press-clamping portion, and therefore the formation of the grooves by knurling or the like is difficult.

In this embodiment, although the coaxial cable shielding terminal for press-connection to the end portion of the single-core coaxial cable 3 has been described, the invention can be applied to the type of coaxial cable shielding terminal for press-connection to a coaxial cable having two or more cores.

In this embodiment, although the retaining portions 27 are formed by embossing (pressing), these retaining portions can be formed by any other suitable means such for example as means for stamping and raising the relevant portions. Alternatively, there can be provided a construction in which the retaining portions 27 are not formed. In this embodiment, although the connecting piece portion 25 extends from the upper portion of the terminal body 9 at the rear end edge thereof, and is bent, a connecting piece portion of any suitable structure can be formed, and for example a connecting piece portion can be formed on the terminal side wall via an interconnecting portion.

Thus, the coaxial cable shielding terminal of the present invention is not limited to this embodiment, but can be modified into any other suitable form.

1. A coaxial cable shielding terminal electrically connected to a braid of said coaxial cable exposed at the end portion thereof comprising:
a press-clamping portion press-connected to an end portion of a coaxial cable, said press-clamping portion including:
a pair of braid press-fastening portions extend in an upstanding manner respectively from opposite side edges of a terminal bottom plate portion, and press-connected to said braid of said coaxial cable by press-fastening;
a connecting piece portion which can be inserted at its distal end portion between an inner insulating layer of said coaxial cable and said braid from the end side of said coaxial cable so that said braid can be held between said connecting piece portion and distal end portions of said braid press-fastening portions; and
grooves of a triangular cross-section formed in an inner surface of said press-clamping portion, and extend in respective directions intersecting a direction of insertion of said coaxial cable,
wherein each of said grooves is formed such that that corner of the triangle, defining a bottom of said groove, is located upstream of a center of an opening of said groove in the direction of insertion of said coaxial cable.

2. A coaxial cable shielding terminal according to claim 1, wherein each of said grooves has a right-angled triangular cross-section such that surface of said groove, disposed at the downstream side in the direction of insertion of said coaxial cable, defines a slanting side of the right-angled triangle.

3. A coaxial cable shielding terminal according to claim 1, wherein the press-clamping portion includes a pair of sheath press-fastening portions disposed rearwardly of said braid press-fastening portions.
